(19) United States
(12) Patent Application Publication
(10) Pub. No.: US 2025/0266916 A1
(43) Pub. Date: Aug. 21, 2025

(54) METHODS FOR INTERFERENCE HANDLING OF BACKSCATTERED WAVEFORM

(71) Applicant: APPLE INC., Cupertino, CA (US)

(72) Inventors: Ankit Bhamri, Bad Nauheim (DE); Wei Zeng, San Diego, CA (US); Chunxuan Ye, San Diego, CA (US); Hong He, San Jose, CA (US); Sigen Ye, San Diego, CA (US); Dan Wu, Beijing (CN); Haitong Sun, Cupertino, CA (US); Dawei Zhang, Saratoga, CA (US); Seunghee Han, San Jose, CA (US)

(21) Appl. No.: 19/046,032

(22) Filed: Feb. 5, 2025

Related U.S. Application Data
(60) Provisional application No. 63/553,812, filed on Feb. 15, 2024.

(51) Int. Cl. H04B 17/345; H04L 27/26

(52) U.S. Cl. CPC H04B 17/345; H04L 27/2649

(57) ABSTRACT

Systems, methods and apparatuses herein provides ways to handle interference to a backscattered signal carrying information from an ambient internet of things (IoT) device. The interference may be from the carrier wave that is used for providing energy to the device. In some embodiments, sequence-based interference handling may be used to minimize the carrier wave interference. In some embodiments delay-based Interference handling may be used to minimize the carrier wave interference.

### TECHNICAL FIELD

This application relates generally to wireless communication systems, including systems to minimize interference to the backscattered signal from an ambient IoT device.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an example D2R transmission timeline where the ambient IoT device is configured to transmit a backscattered signal modulated with preamble sequence at the beginning of every communication round (e.g., at start of PUSCH or PDRCH) in accordance with some embodiments.

FIG. 1B illustrates an example D2R transmission timeline where the ambient IoT device is configured to periodically transmit backscatter signal modulated with a sequence in accordance with some embodiments.

FIG. 1C illustrates an example transmission timeline where the ambient IoT device can be signaled to transmit backscattered signal modulated with a sequence on indicated time resources in a dynamic manner in accordance with some embodiments.

FIG. 2 shows an example of delay-based interference handling in accordance with one or more embodiments of the present disclosure.

FIG. 3 illustrates a method for a reader, according to embodiments herein.

FIG. 4 illustrates a method for an ambient IoT device, according to embodiments herein.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Additionally, embodiments herein are described with regard to Internet of Things (IoT) devices. Reference to an IoT device is merely provided for illustrative purposes, and the embodiment herein may be utilized with any device that have the capability to collect and exchange data. IoT devices may be embedded with sensors, software, and network connectivity, allowing them to communicate with other devices and systems. IoT devices can vary in size, complexity, and functionality. They can range from small, simple devices such as temperature sensors and smart home appliances to more complex devices like industrial machinery and autonomous vehicles.

Some IoT devices include ambient IoT devices. An ambient IoT device is a device that is able to harvest energy from ambient sources. For example, some ambient IoT devices may use radio frequency (RF) waves for power. To power such devices using RF, embodiments herein provide enhancements to a wireless communication system framework to introduce a new category of device(s) that is able to harvest energy from ambient sources. An ambient IoT device may be referred to as an RF powered device. An ambient IoT device may also be a UE device.

There may be multiple types of ambient IoT devices that the wireless communication system may support. For instance, in terms of energy storage, some devices may be battery-less devices with no energy storage capability at all, and completely dependent on the availability of an external source of energy. Some devices may include limited energy storage capability that do not need to be replaced or recharged manually, but can be charged by harvesting energy from ambient sources. In some embodiments, device categorization may be based on characteristics corresponding to a device (e.g., energy source, energy storage capability, passive/active transmission, etc.).

Embodiments herein consider the following set of ambient IoT devices. A first device type, (Device 1) may operate with around one microwatt (μW) peak power consumption, have energy storage, have an initial sampling frequency offset (SFO) up to 10× parts per million (ppm) (e.g., 105 ppm), and provide neither reader-to-device (R2D) (e.g., downlink) nor device-to-reader (D2R) (e.g., downlink) amplification. The first device type's UL transmission is backscattered on a carrier wave provided externally. For instance, a device may not generate its own active transmission, and reflect or backscatter an incoming signal (carrier wave).

A second device type (Device 2a) may operate with up with a peak power consumption of up to a few hundred u W, have energy storage, have an initial SFO up to 10× ppm, and provide both DL and/or UL amplification in the second device. The second device type's UL transmission is backscattered on a carrier wave provided externally.

A third device type (Device 2b) may operate with up with a peak power consumption of up to a few hundred u W, have energy storage, have an initial SFO up to 10× ppm, and provide both DL and/or UL amplification in the third device. The third device type's UL transmission may be generated internally by the device.

Note that R2D in ambient IoT may be referred to as downlink and the channel for the R2D may be referred to as physical reader to device channel (PRDCH). D2R in ambient IoT may be referred to as uplink and the channel for the D2R may be referred to as physical device to reader channel (PDRCH). The reader may be a base station or a UE.

For both Device 1 and Device 2a devices categories, backscattering is supported. That is, the carrier wave that is generated externally to the ambient IoT device is received and reflected back by the device. As a result, this could lead to potential interference between the carrier wave and the backscattered wave, especially, at the reader and/or the intermediate node. One objective of ambient IoT systems is handling interference in this scenario because the reflected/backscattered signal and the carrier wave signal may be on the same frequency and same time symbol.

Some embodiments herein provide ways to handle the interference. Some embodiments herein minimize the interference to the backscattered signal carrying information from the ambient IoT device from the carrier wave that is used for providing energy to the device. In some embodiments, measurement and suppression based interference handling (also referred to as sequence-based interference handling) may be used. In some embodiments, delay-based interference handling may be used.

For an ambient IoT device, a sequence may be used for the purpose of interference measurement at the reader and/or an intermediate node (e.g., UE). The sequence used may be a preamble sequence, a midamble sequence, and/or a postamble sequence in some embodiments, the sequence-based interference handling can include one or more steps. A first step of the sequence-based interference handling may include pre-configuring an ambient IoT device with a preamble sequence, a midamble sequence, and/or a postamble sequence. In a second step, the reader (either directly (e.g., base station or UE) or via intermediate node (e.g., UE)) may transmit an unmodulated carrier wave to the ambient IoT device. In a third step, an ambient IoT device may receive the unmodulated carrier wave and modulate the wave with a preamble sequence, a midamble sequence, and/or a postamble sequence and backscatter to the reader and/or intermediate node. In a fourth step, the reader and/or intermediate node may receive the backscattered signal and demodulate it using the pre-configured preamble sequence, a midamble sequence, and/or a postamble sequence. In a fifth step, the reader can determine the self-interference at its receiver. In a sixth step, the reader can apply a determined self-interference for signal reception from the ambient IoT device by interference cancellation.

Thus, in some embodiments the ambient IoT device may backscatter the preconfigured preamble sequence, a midamble sequence, and/or a postamble sequence that the ambient IoT device. This may help the reader to do an interference measurement. Once the reader does the interference measurement on the preamble part, a midamble part, and/or a postamble part, then the reader may know the interference that was introduced as a result of the carrier wave. The reader can use the interference measurement to suppress or cancel or subtract out the interference when information is transmitted by the ambient IoT device.

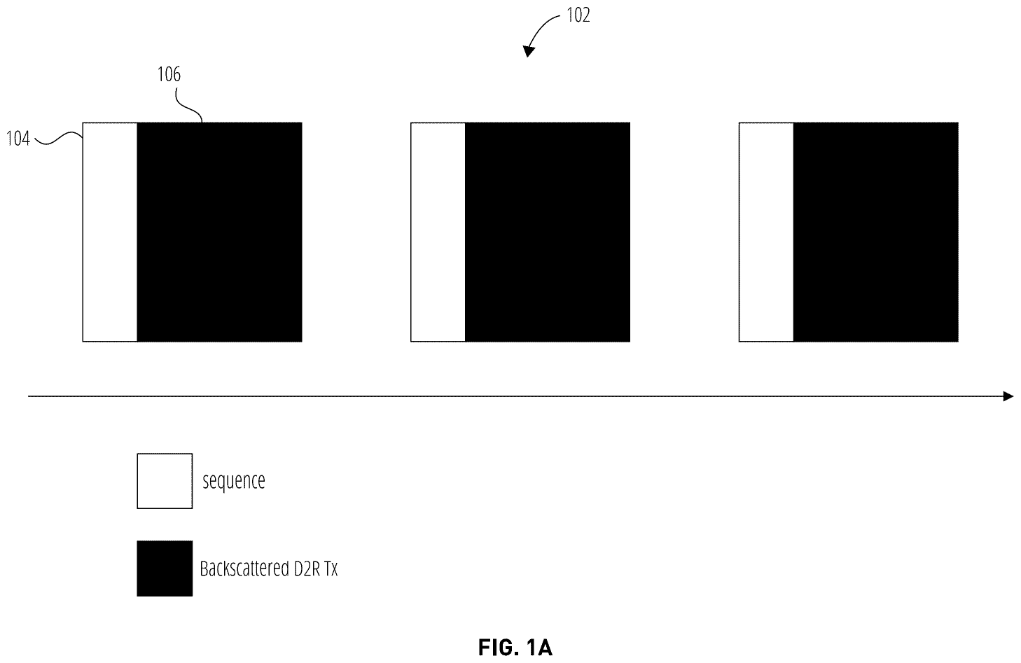

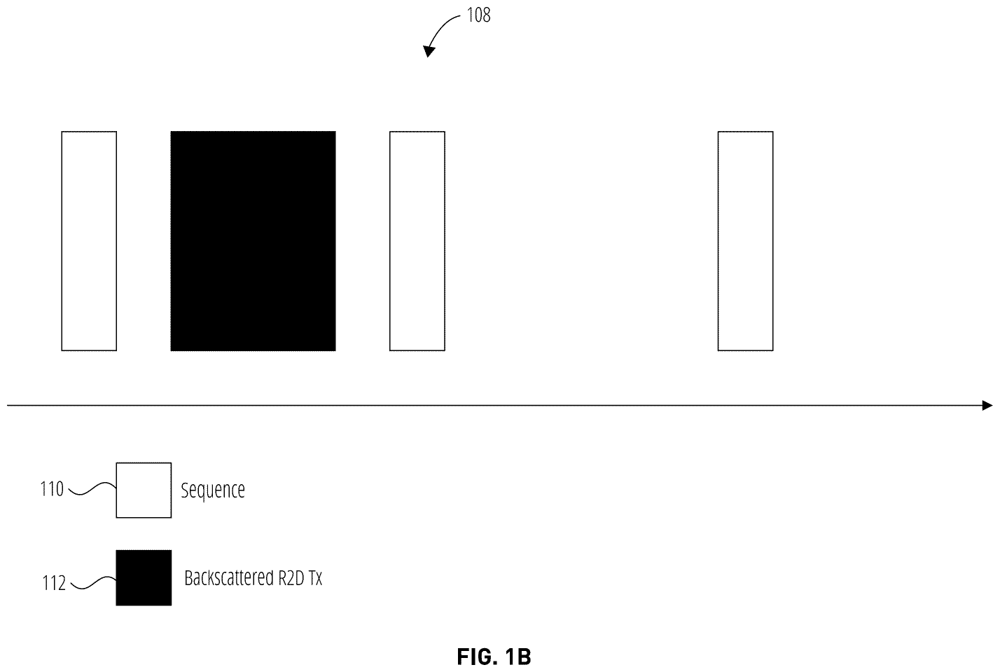

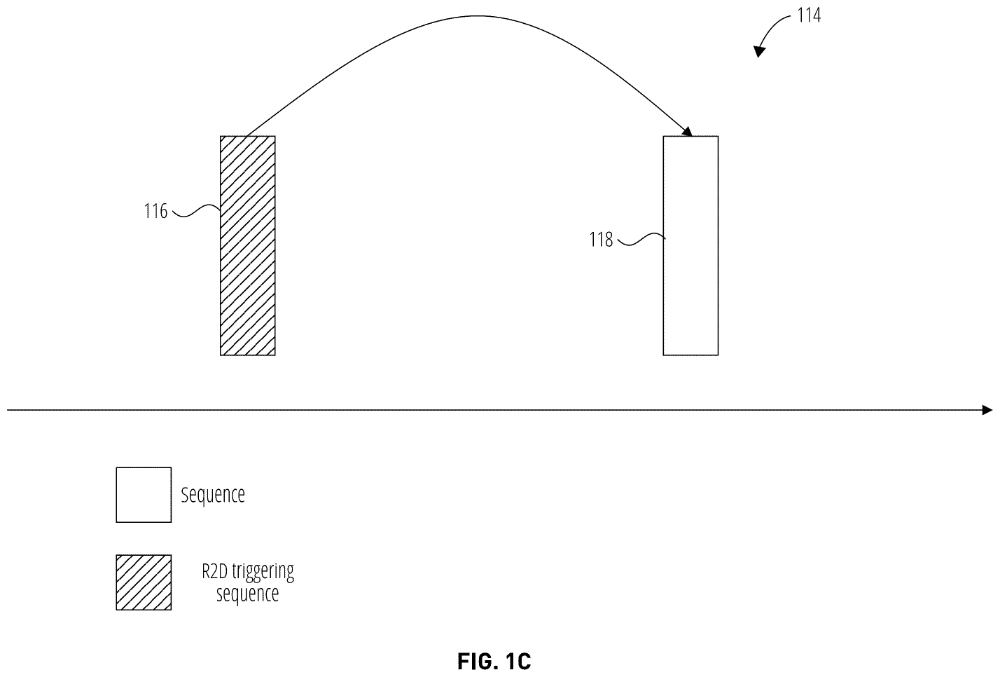

FIG. 1A, FIG. 1B and FIG. 1C show examples of different ways in which sequence-based interference handling may be enabled. In the illustrated examples, a preamble sequence, a midamble sequence, and/or a postamble sequence may be used for the purpose of interference measurement at the reader and/or intermediate node (UE). While examples herein use a preamble sequence, the same principles may be used for embodiments that use a midamble or postamble sequence.

Specifically, FIG. 1A illustrates an example D2R transmission timeline 102 where the ambient IoT device is configured to transmit a backscattered signal modulated with a sequence at the beginning of every communication round (e.g., at start of PUSCH or PDRCH) in accordance with some embodiments. For example, in the illustrated embodiment the ambient IoT device may first backscatter the preamble 104 and then the ambient IoT device may send a backscattered D2R transmission 106 with the uplink data. This preamble may be used before each backscattered D2R transmission. In such embodiments, each backscattered D2R transmission may be associated with a preamble sequence.

The reader may use the preamble to determine interference and cancel the interference for signal reception of the backscattered D2R transmission. Accordingly, whenever the D2R channel is used for a transmission transmitted, a preamble sequence may be used for interference handling.

FIG. 1B illustrates an example D2R transmission timeline 108 where the ambient IoT device is configured to periodically transmit backscatter signal modulated with a sequence in accordance with some embodiments. In the illustrated embodiment, the transmission of the sequence is independent of the communication round. For example, as shown the sequence 110 is periodically transmitted by the ambient IoT device, and the backscattered D2R transmission 112 occurs independently from the sequence 110.

In such embodiments, there may be no direct association or relationship between when the backscattered D2R transmission 112. The reader may use the periodic sequence transmission to measure the interference. The reader may use the measured interference to suppress or remove the interference from the data channel.

FIG. 1C illustrates an example transmission timeline 114 where the ambient IoT device can be signaled to transmit backscattered signal modulated with a sequence on indicated time resources in a dynamic manner in accordance with some embodiments. As shown, the reader may send an R2D signal triggering sequence 116. The R2D signal triggering sequence 116 may signal to the ambient IoT device to transmit a backscattered signal modulated with a sequence on indicated time resources. The ambient IoT device may send the backscattered signal modulated with sequence 118 based on the R2D signal triggering sequence 116.

The illustrated embodiment provides a dynamic signaling mechanism for the backscattered signal modulated with sequence 118. In some embodiments, whenever the reader is interested in a new interference measurements, the reader can trigger the ambient IoT device to transmit the backscattered signal modulated with sequence 118. The backscattered signal modulated with sequence 118 does not have to be periodic or associated with a corresponding data channel transmission. The reader may use the backscattered signal modulated with sequence 118 to measure the interference. The reader may use the measured interference to suppress or remove the interference from the data channel.

In some embodiments, the reader and ambient IoT devices may use different types of topologies. In a first deployment scenario, the reader may directly interface with the ambient IoT device. In a second deployment scenario, a reader and ambient IoT device may communicate through an intermediate node.

In some embodiments for ambient IoT devices served with the reader via an intermediate node (e.g., UE), the sequence-based measurement can be done at various stages. In at least one embodiment, the sequence-based measurement can be done at the reader (e.g., base station). For example, the intermediate node may forward the backscattered signal modulated with a sequence to the reader without any processing. The reader may process the backscattered signal modulated with the sequence and measure the interference. The reader may use the measured interference to suppress or remove the interference from the data channel.

In some embodiments that use an intermediate node, the preamble, a midamble sequence, and/or a postamble sequence-based measurement can be done at the intermediate node. For example, the intermediate node may perform an interference signal measurement and cancel the interference from the received backscattered signal. The intermediate node may forward the processed signal to the reader. In such embodiments, the intermediate node can be provided with the configuration associated with the sequence and corresponding time resource determination (similar to that signaled to ambient IoT device). For example, the reader or network may send the configuration to the intermediate node.

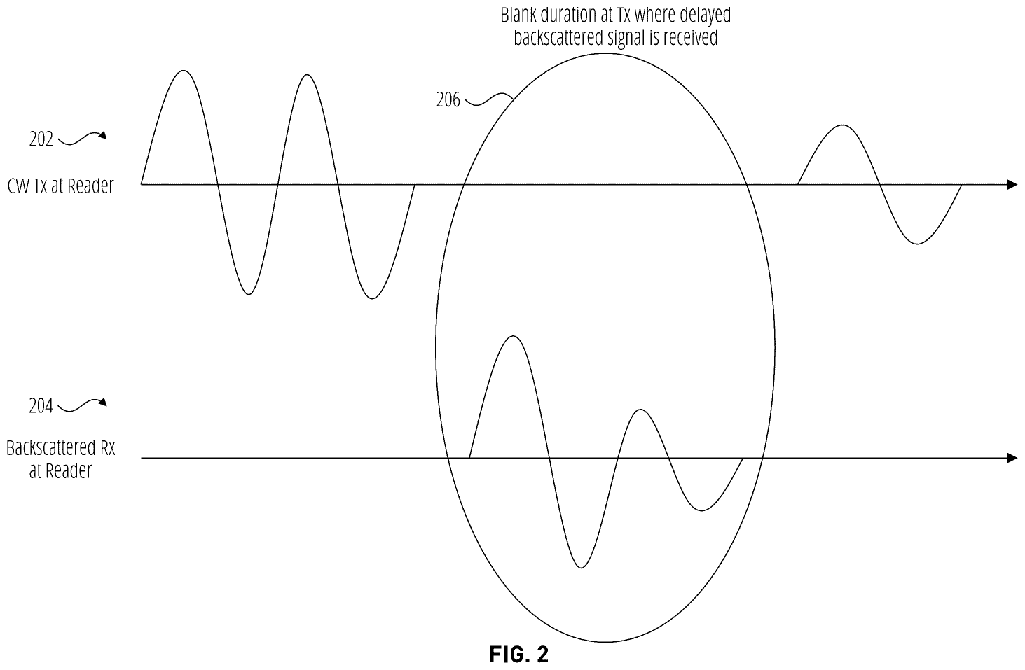

FIG. 2 shows an example of delay-based interference handling in accordance with one or more embodiments of the present disclosure. In at least one embodiment for ambient IoT devices configured to use backscattering communication, the ambient IoT devices can be configured to receive a carrier wave with intermittent nulling/blanking/pause and have a corresponding delayed backscattered transmission.

The signals in FIG. 2 are illustrated from the readers point of view. As shown, the reader may transmit a carrier wave 202. There may be a blanked duration 206 where the carrier wave 202 is not transmitted and the delayed backscattered signal 204 is received. As shown the ambient IoT device may delay sending the backscattered signal 204 until the blanked duration 206. The reader may not be expected to transmit any carrier way within that blanked duration 206. Instead, the blanked duration 206 is a gap where the reader receives the backscattered signal 204.

In some embodiments, the delayed backscattering transmission can be based on a round trip time (RTT) delay at the reader side for reception of the backscattered signal 204 from the ambient IoT device. In at least one embodiment, between two intermittent blanking, the duration of the carrier wave can be shorter than or equal to the RTT delay. The RTT delay may refer to the time it takes for a signal to travel from a reader to the ambient IoT device and back again to the reader.

In such embodiments, the RTT delay may be used to define the duration of the of the carrier wave 202 before a blanked duration 206. In some embodiments, the duration of a single carrier wave instance may not be larger than the RTT delay. Accordingly, the duration of the carrier wave 202 before a gap may be smaller or equal to the blanked duration 206. The blank duration may avoid interference between the carrier wave 202 and the backscattered signal 204.

In some embodiments, the delayed backscattering transmission (e.g., backscattered signal 204) can be based on an artificially induced delay at the ambient IoT device itself, e.g., via transmission-line delay. In some embodiments, between two intermittent blanking, the duration of carrier wave 202 can be shorter than or equal to artificially induced delay. This can enable the backscattered signal 204 to be received during the blanked duration 206 by the reader or intermediate node.

In some embodiments, for ambient IoT device backscattered communication capable of artificially induced delay, the reader may activate/trigger the device to apply the artificial delay for the backscattered signal. In at least one embodiment, the ambient IoT device may report or be capable of only fixed artificially delay value. In another embodiment, the ambient IoT device may be able to adjust its delay according to configured/indicated value by the reader, wherein the maximum and/or minimum delay value can be based on device's reported capability. In such embodiments, the ambient IoT device may report its capability, and the reader may determine a maximum and/or minimum delay value for the ambient IoT device. The reader may configure/indicate a delay value for the ambient IoT device within the maximum and/or minimum delay value.

In some embodiments, for an ambient IoT device backscattered communication with artificially induced delay, the packet size of the data to be encoded/modulated in the backscattered signal can be determined based on the duration of the delay. For example, if the duration is 1 symbol, then maximum packet size can be determined accordingly. Accordingly, the packet size may correspond to the duration of the delay.

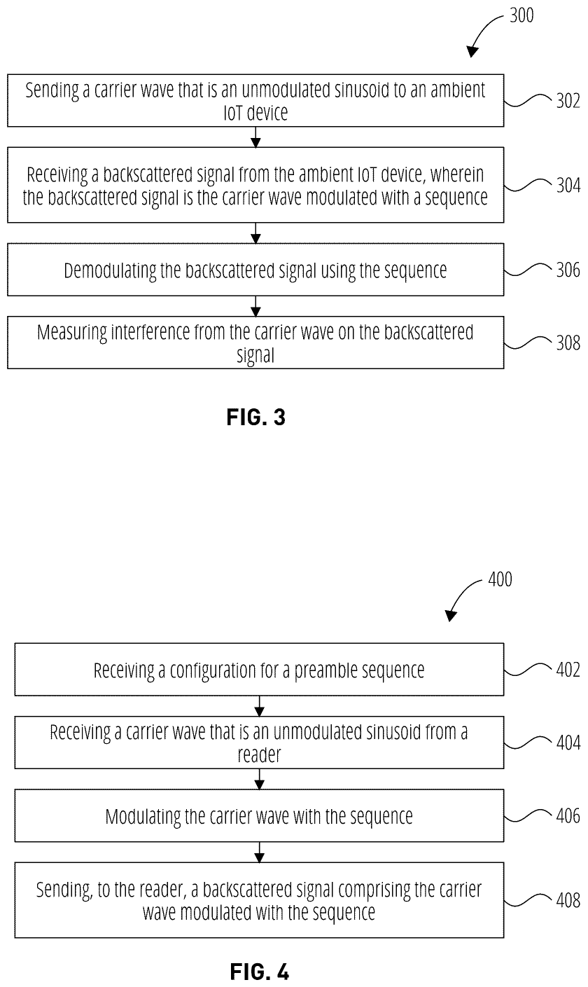

FIG. 3 illustrates a method 300 for a reader, according to embodiments herein. The illustrated method 300 includes sending 302 a carrier wave that is an unmodulated sinusoid to an ambient IoT device. The method 300 further includes receiving 304 a backscattered signal from the ambient IoT device, wherein the backscattered signal is the carrier wave modulated with a sequence. The method 300 further includes demodulating 306, method 300 the backscattered signal using the sequence. The method 300 further includes measuring 308 interference from the carrier wave on the backscattered signal.

In some embodiments of the method 300, the sequence is pre-configured.

In some embodiments, the method 300 further comprises performing interference cancelation for a future signal reception from the ambient IoT device based on the interference.

In some embodiments of the method 300, the backscattered signal that is modulated with the sequence is received at a beginning of every communication round.

In some embodiments of the method 300, the backscattered signal that is modulated with the sequence is received from the ambient IoT device periodically.

In some embodiments, the method 300 further comprises sending, to the ambient IoT device, an indication of time resources on which the ambient IoT device is to send the backscattered signal that is modulated with the.

In some embodiments of the method 300, the backscattered signal that is modulated with the sequence is forwarded from an intermediate node, and wherein the interference is measured at the reader.

In some embodiments, the method 300 further comprises providing an intermediate node with the sequence, wherein the intermediate node performs interference measurements and cancels the interference, and receiving, from the intermediate node, an ambient IoT device signal that is processed such that the interference is canceled.

FIG. 4 illustrates a method 400 for an ambient IoT device, according to embodiments herein. The illustrated method 400 includes receiving 402 a configuration for a sequence. The method 400 further includes receiving 404 a carrier wave that is an unmodulated sinusoid from a reader. The method 400 further includes modulating 406 the carrier wave with the sequence. The method 400 further includes sending 408, to the reader, a backscattered signal comprising the carrier wave modulated with the sequence.

In some embodiments of the method 400, the backscattered signal comprising the carrier wave modulated with the sequence is sent for interference measurement.

In some embodiments of the method 400, the backscattered signal comprising the carrier wave modulated with the sequence is sent at a beginning of every communication round.

In some embodiments of the method 400, the backscattered signal comprising the carrier wave modulated with the sequence is sent periodically.

In some embodiments, the method 400 further comprises receiving, from the reader, an indication of time resources on which to send the backscattered signal comprising the carrier wave modulated with the sequence.

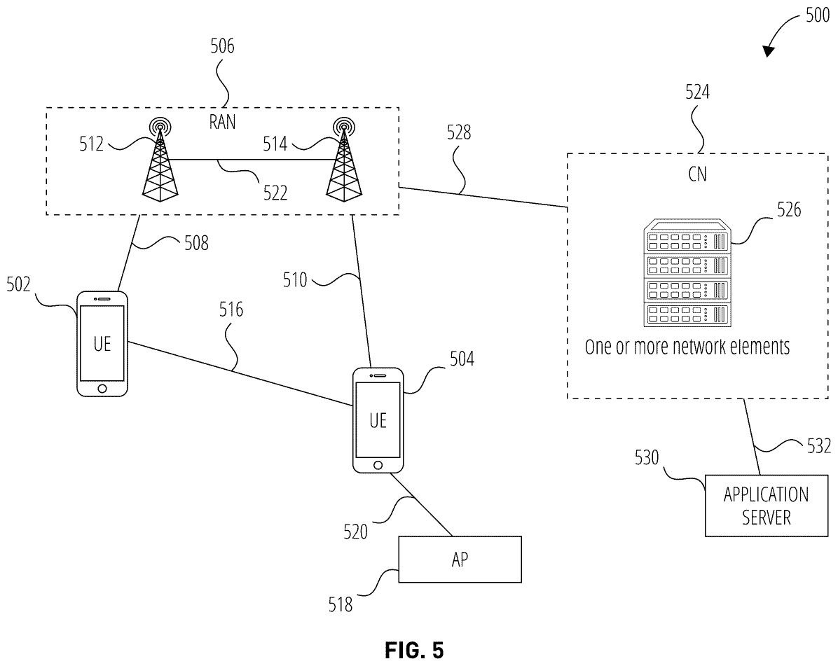

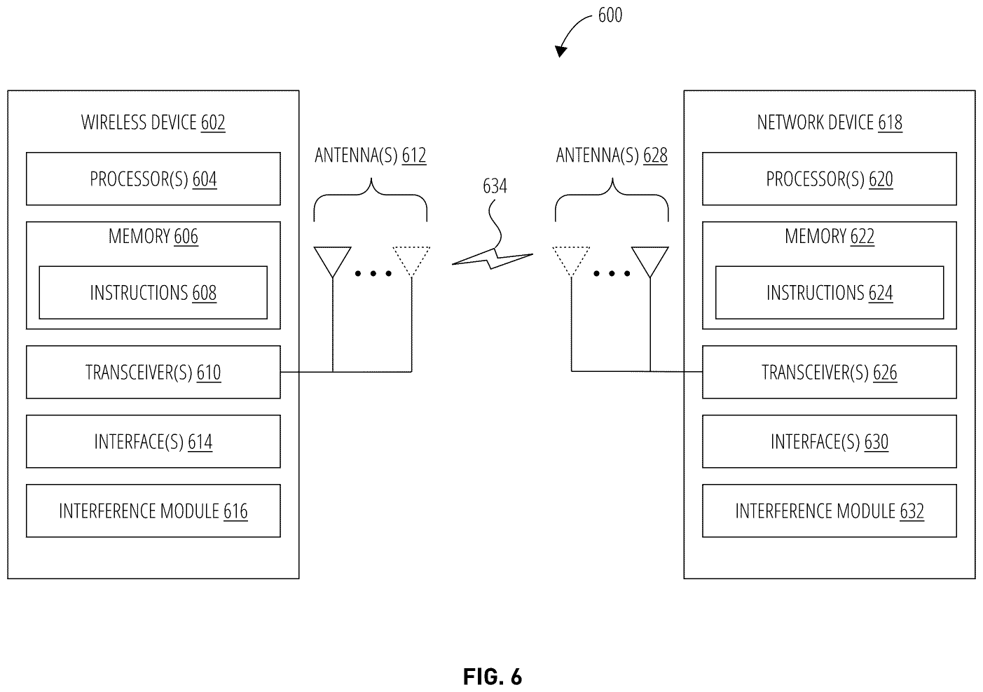

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations (such as base station 512 and base station 514) that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VOIP sessions, group communication sessions, etc.) for the UE 502 and UE 504 via the CN 524. The application server 530 may communicate with the CN 524 through an IP communications interface 532.

FIG. 6 illustrates a system 600 for performing signaling 634 between a wireless device 602 and a network device 618, according to embodiments disclosed herein. The system 600 may be a portion of a wireless communications system as herein described. The wireless device 602 may be, for example, a UE of a wireless communication system. The network device 618 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter circuitry and/or receiver circuitry that use the antenna(s) 612 of the wireless device 602 to facilitate signaling (e.g., the signaling 634) to and/or from the wireless device 602 with other devices (e.g., the network device 618) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include an interference module 616. The interference module 616 may be implemented via hardware, software, or combinations thereof. For example, the interference module 616 may be implemented as a processor, circuit, and/or instructions 608 stored in the memory 606 and executed by the processor(s) 604. In some examples, the interference module 616 may be integrated within the processor(s) 604 and/or the transceiver(s) 610. For example, the interference module 616 may be implemented by a combination of software components (e.g., executed by a DSP or a general processor) and hardware components (e.g., logic gates and circuitry) within the processor(s) 604 or the transceiver(s) 610.

The interference module 616 may be used for various aspects of the present disclosure, for example, aspects of FIGS. 1-5.

The network device 618 may include one or more processor(s) 620. The processor(s) 620 may execute instructions such that various operations of the network device 618 are performed, as described herein. The processor(s) 620 may include one or more baseband processors implemented using, for example, a CPU, a DSP, an ASIC, a controller, an FPGA device, another hardware device, a firmware device, or any combination thereof configured to perform the operations described herein.

The network device 618 may include a memory 622. The memory 622 may be a non-transitory computer-readable storage medium that stores instructions 624 (which may include, for example, the instructions being executed by the processor(s) 620). The instructions 624 may also be referred to as program code or a computer program. The memory 622 may also store data used by, and results computed by, the processor(s) 620.

The network device 618 may include one or more transceiver(s) 626 that may include RF transmitter circuitry and/or receiver circuitry that use the antenna(s) 628 of the network device 618 to facilitate signaling (e.g., the signaling 634) to and/or from the network device 618 with other devices (e.g., the wireless device 602) according to corresponding RATs.

The network device 618 may include one or more antenna(s) 628 (e.g., one, two, four, or more). In embodiments having multiple antenna(s) 628, the network device 618 may perform MIMO, digital beamforming, analog beamforming, beam steering, etc., as has been described.

The network device 618 may include one or more interface(s) 630. The interface(s) 630 may be used to provide input to or output from the network device 618. For example, a network device 618 that is a base station may include interface(s) 630 made up of transmitters, receivers, and other circuitry (e.g., other than the transceiver(s) 626/antenna(s) 628 already described) that enables the base station to communicate with other equipment in a core network, and/or that enables the base station to communicate with external networks, computers, databases, and the like for purposes of operations, administration, and maintenance of the base station or other equipment operably connected thereto.

The network device 618 may include an interference module 632. The interference module 632 may be implemented via hardware, software, or combinations thereof. For example, the interference module 632 may be implemented as a processor, circuit, and/or instructions 624 stored in the memory 622 and executed by the processor(s) 620. In some examples, the interference module 632 may be integrated within the processor(s) 620 and/or the transceiver(s) 626. For example, the interference module 632 may be implemented by a combination of software components (e.g., executed by a DSP or a general processor) and hardware components (e.g., logic gates and circuitry) within the processor(s) 620 or the transceiver(s) 626.

The interference module 632 may be used for various aspects of the present disclosure, for example, aspects of FIGS. 1-5.

Embodiments contemplated herein include an apparatus comprising means to perform one or more elements of the method 400. This apparatus may be, for example, an apparatus of a UE (such as a wireless device 602 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 606 of a wireless device 602 that is a UE, as described herein).

Embodiments contemplated herein include an apparatus comprising logic, modules, or circuitry to perform one or more elements of the method 400. This apparatus may be, for example, an apparatus of a UE (such as a wireless device 602 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 602 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 604 of a wireless device 602 that is a UE, as described herein). These instructions may be, for example, located in the processor and/or on a memory of the UE (such as a memory 606 of a wireless device 602 that is a UE, as described herein).

Embodiments contemplated herein include an apparatus comprising means to perform one or more elements of the method 300. This apparatus may be, for example, an apparatus of a base station (such as a network device 618 that is a base station, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a base station (such as a memory 622 of a network device 618 that is a base station, as described herein).

Embodiments contemplated herein include an apparatus comprising logic, modules, or circuitry to perform one or more elements of the method 300. This apparatus may be, for example, an apparatus of a base station (such as a network device 618 that is a base station, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a base station (such as a network device 618 that is a base station, as described herein).

Embodiments contemplated herein include a signal as described in or related to one or more elements of the method 300.

Embodiments contemplated herein include a computer program or computer program product comprising instructions, wherein execution of the program by a processing element is to cause the processing element to carry out one or more elements of the method 300. The processor may be a processor of a base station (such as a processor(s) 620 of a network device 618 that is a base station, as described herein). These instructions may be, for example, located in the processor and/or on a memory of the base station (such as a memory 622 of a network device 618 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a reader, the method comprising:
sending a carrier wave that is an unmodulated sinusoid to an ambient Internet of Things (IoT) device;
receiving a backscattered signal from the ambient IoT device, wherein the backscattered signal is the carrier wave modulated with a sequence;
demodulate the backscattered signal using the sequence; and
measuring interference from the carrier wave on the backscattered signal.

2. The method of claim 1, wherein the sequence is pre-configured.

3. The method of claim 1, further comprising performing interference cancelation for a future signal reception from the ambient IoT device based on the interference.

4. The method of claim 1, wherein the backscattered signal that is modulated with the sequence is received at a beginning of every communication round.

5. The method of claim 1, wherein the backscattered signal that is modulated with the sequence is received from the ambient IoT device periodically.

6. The method of claim 1, further comprising sending, to the ambient IoT device, an indication of time resources on which the ambient IoT device is to send the backscattered signal that is modulated with the sequence.

7. The method of claim 1, wherein the backscattered signal that is modulated with the sequence is forwarded from an intermediate node that is a second reader, and wherein the interference is measured at the second reader.

8. The method of claim 1, further comprising:
providing an intermediate node with the sequence, wherein the intermediate node performs interference measurements and cancels the interference, and
receiving, from the intermediate node, an ambient IoT device signal that is processed such that the interference is canceled.

9. A method for an ambient Internet of Things (IoT) device, the method comprising:
receiving a configuration for a sequence;
receiving a carrier wave that is an unmodulated sinusoid from a reader;
modulating the carrier wave with the sequence; and
sending, to the reader, a backscattered signal comprising the carrier wave modulated with the sequence.

10. The method of claim 9, wherein the backscattered signal comprising the carrier wave modulated with the sequence is sent for interference measurement.

11. The method of claim 9, wherein the backscattered signal comprising the carrier wave modulated with the sequence is sent at a beginning of every communication round.

12. The method of claim 9, wherein the backscattered signal comprising the carrier wave modulated with the sequence is sent periodically.

13. The method of claim 9, further comprising receiving, from the reader, an indication of time resources on which to send the backscattered signal comprising the carrier wave modulated with the sequence.

14. A reader apparatus comprising:
a processor; and
a memory storing instructions that, when executed by the processor, configure the reader apparatus to:
send a carrier wave that is an unmodulated sinusoid to an ambient Internet of Things (IoT) device;
receive a backscattered signal from the ambient IoT device, wherein the backscattered signal is the carrier wave modulated with a sequence;
demodulate the backscattered signal using the sequence; and
measure interference from the carrier wave on the backscattered signal.

15. The reader apparatus of claim 14, wherein the sequence is pre-configured.

16. The reader apparatus of claim 14, wherein the instructions further configure the reader apparatus to perform interference cancelation for a future signal reception from the ambient IoT device based on the interference.

17. The reader apparatus of claim 14, wherein the backscattered signal that is modulated with the sequence is received at a beginning of every communication round.

18. The reader apparatus of claim 14, wherein the backscattered signal that is modulated with the sequence is received from the ambient IoT device periodically.

19. The reader apparatus of claim 14, wherein the instructions further configure the apparatus to send, to the ambient IoT device, an indication of time resources on which the ambient IoT device is to send the backscattered signal that is modulated with the sequence.

20. The reader apparatus of claim 14, wherein the backscattered signal that is modulated with the sequence is forwarded from an intermediate node that is a second reader, and wherein the interference is measured at the second reader.
